(19) United States
(12) Patent Application Publication
(10) Pub. No.: US 2008/0316516 A1
(43) Pub. Date: Dec. 25, 2008

(54) IMAGE PROCESSING APPARATUS, IMAGE PROCESSING METHOD, AND STORAGE MEDIUM FOR PREVENTING UNJUST COPYING

(76) Inventor: Takeshi Kajikawa, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/142,494

(22) Filed: Jun. 19, 2008

(30) Foreign Application Priority Data
Jun. 19, 2007 (JP) 2007-161193
Apr. 23, 2008 (JP) 2008-112321

(51) Int. Cl. G06F 3/12

(52) U.S. Cl. 358/1.13

(57) ABSTRACT

An image processing apparatus including an image input module configured to input a document image; a detect module configured to detect whether copy control information is provided with document image data of the document image; a transfer module configured to transfer the document image data through a network in case the detect module detects the copy control information; an edit module configured to edit the document image data, and create an edited image according to the copy control information; and an image output module configured to output the edited image.

### CROSS REFERENCE TO RELATED APPLICATIONS

This application is based upon and claims priority under 35 U.S.C. § 119 from Japanese Patent Application No. 2007-161193, filed Jun. 19, 2007, and Japanese Patent Application No. 2008-112321, filed Apr. 23, 2008, the entire contents of which are hereby incorporated by reference.

### BACKGROUND OF THE INVENTION

1. Field of the Invention

The present invention generally relates to an image processing apparatus, an image processing method, and a storage medium, and more particularly, to an image processing apparatus and an image processing method that has an unjust copy prevention function.

2. DESCRIPTION OF THE RELATED ART

Leaking information provided on a paper document is a problem in some companies. Thus, in many cases there is a prohibition against copying a paper document including confidential information. In this kind of situation, technologies to restrain/prevent copying of the paper document (hereinafter, called “unjust copying”) are known in the related art.

For example, a copy management system is known including a digital multi-function peripheral (hereinafter, called “MFP”) and a management server. A document image, when making a copy of a document, is read by a scan unit of the MFP, sent to the management server through a network, stored by the management server, and managed/referred to by an observation manager. This copy management system may have a restraining effect on unjust copying due to the observation feature. See, for example, US Laid-Open Patent Application No. US20060197980.

In addition, a digital MFP with an unjust copy prevention function is known. The MFP decides whether the document read by a scanner of the MFP is a confidential document or not based on whether special information is detected. For example, a special ground pattern can be provided on the document. If it is decided that the read document is a confidential document, then the MFP destroys the read image by, for example, converting the image to an all gray image. (hereinafter called a “destruction feature”) See, for example, US Laid-Open Patent Application No. US20050078331 or US Laid-Open Patent Application No. US20060197980.

### SUMMARY OF THE INVENTION

The inventors recognized that trying to build a copy management system combining the observation feature and the destruction feature as described above with regard to the related art would result in the read image being destroyed and transmitted to a management server in its destroyed form. As a result, when checking the stored image, the observation manager would not recognize the original document contents subjected to the unjust copy attempt.

Embodiments of the present invention provide an image processing apparatus, a image processing method, and a recordable storage medium containing program code for causing a computer to perform an image processing method that solves or reduces one or more of the problems caused by the limitations and disadvantages of the related art, and to reduce unjust copying effectively by inputting a document image, detecting whether copy control information is provided with the document image data, transferring the document image data through a network in case the copy control information is detected, editing the document image data to create an edited image according to the copy control information and outputting the edited image.

### BRIEF DESCRIPTION OF THE DRAWINGS

FIG. 1 illustrates a configuration of an image processing apparatus according to an embodiment of the present invention;

FIG. 2 illustrates a software control configuration of an image processing apparatus according to an embodiment of the present invention;

FIG. 3 illustrates a configuration of an unjust prevention unit of an image processing apparatus according to an embodiment of the present invention;

FIG. 4 is a sequence chart showing a method for managing unjust copying according to an embodiment of the present invention;

FIG. 5 is a flow chart showing a method for managing unjust copying according to an embodiment of the present invention; and

FIG. 6 illustrates an example of an e-mail data sent to an observation manager when an unjust copying has occurred according to an embodiment of the present invention.

### DETAILED DESCRIPTION OF THE PREFERRED EMBODIMENTS

Preferred embodiments of the present invention are described below with reference to the accompanying drawings, but the present invention is not limited to those embodiments.

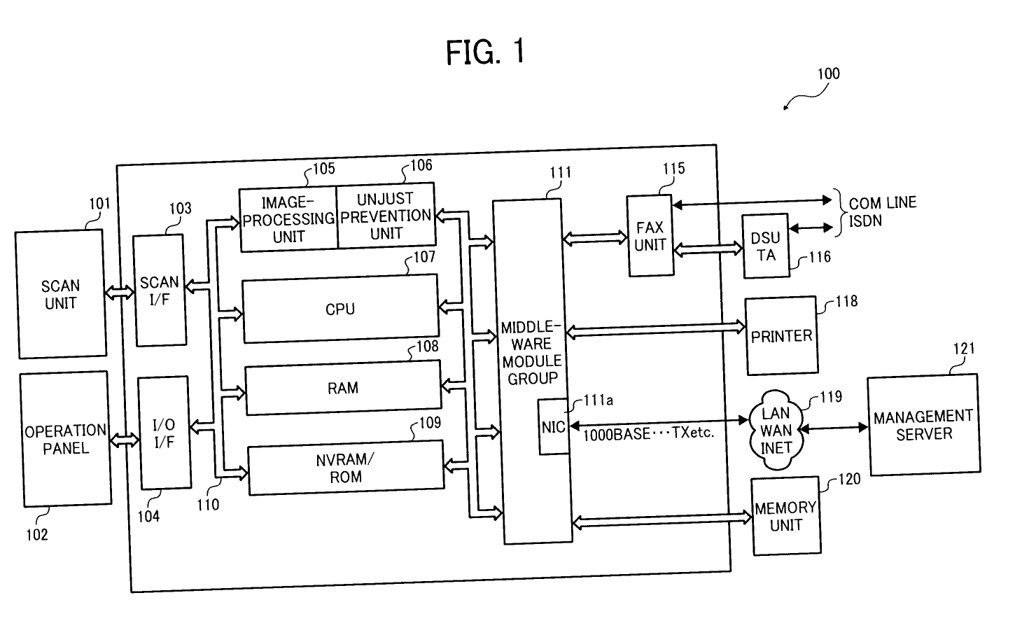

Referring to FIG. 1, an image processing apparatus 100 acquires a document image from a scan unit 101 with an ADF (auto document feeder), and acquires input data from the operation panel 102. The document image is sent to an image-processing unit 105 through the scan I/F 103. The image-processing unit 105 performs, for example, a filtering processing, a letter-image separation/extraction processing, and a halftone processing to generate document image data (for example, a raster image data), and sends the document image data to the unjust copy prevention unit 106.

The unjust copy prevention unit 106 judges the document image to determine whether the document is prohibited from being copied by detecting copy control information. In case the document is prohibited from being copied, the image processing apparatus 100 prevents unjust copying by destroying data regarding color or the like such that contents of the document are not recognizable upon being output. Destroying collar information includes, for example, converting image data to all gray, or overlaying a pattern mask image on the document image.

The image-processing unit 105 and the unjust copy prevention unit 106 may be implemented in many of the modules of the image processing apparatus 100. For example, the unjust copy prevention unit can be implemented as a module of the scanner application/scanner engine which treats the document image in the image processing apparatus 100.

The copy control information of this embodiment can be added to the document using various methods. For example, a user can print the document from a printer driver of a computer with instructions to overlay a particular image (for example, a specific character string, a specific image, or a digital watermark) on the document image which reflects that the document is prohibited from being copied.

The image processing apparatus 100 includes a CPU 107, a RAM 108, and NVRAM/ROM 109.

The image processing apparatus 100 manages execution of a plurality of software processing modules using the CPU 107, the RAM 108, and the NVRAM/ROM 109.

The image processing apparatus 100 includes a plurality of controllers as a middleware module group 111. The controllers include, for example, a facsimile controller for controlling a FAX unit 115 and a DSU/TA 116, an engine controller for controlling a printer unit 118, a memory resource controller for controlling a memory unit 120 such as a HDD which stores the document image data and the destroyed document image data as part of a job log. The job log is used to provide operation information of the document image in the case when a notice of unjust copying is transmitted to a management server 121. A communication controller for controlling communication through a network 119 to the management server 121 is also provided.

In addition, the job log may be stored in the NVRAM 109 or another solid storage device of the image processing apparatus 100 instead of the memory unit 120.

The scan unit 101 reads a document and acquires the document image from the document when a user instruction requesting an output (for example, copy, fax, email, file upload through the network) of the document image is requested via the operation panel I/O I/F unit 104 of the image processing apparatus 100.

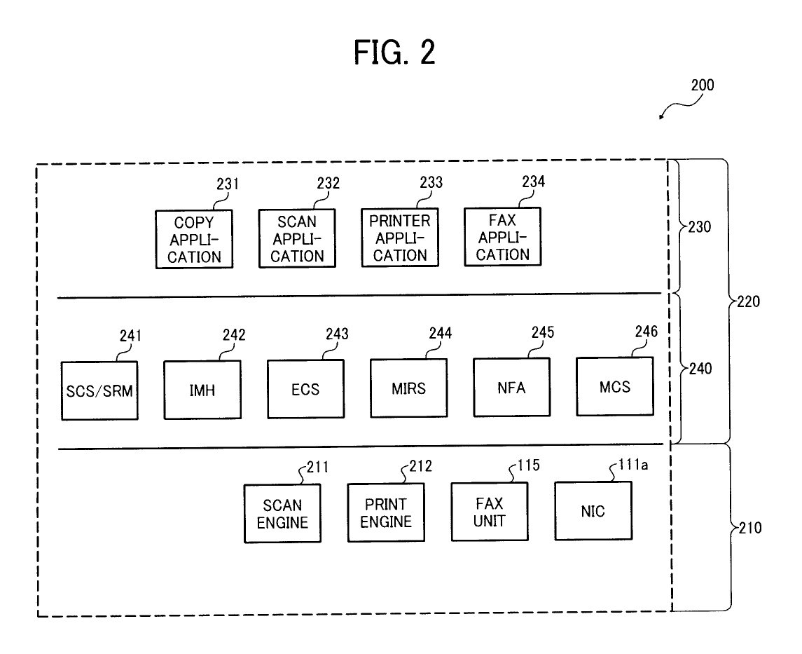

Referring to FIG. 2, a control level block 200 of the image processing apparatus 100 includes a hardware layer 210 and software layer 220. The software layer 220 includes an application layer 230 and a middleware layer 240. The hardware layer 210 includes an engine group (for example, scan engine 211, print engine 212, NIC 111a, and FAX unit 115) and a device driver for the engine group.

The application layer 230 includes a copy application 231, a scan application 232, a printer application 233, and a FAX application 234, where these applications provide the user various functions.

In this embodiment, the document image is handled with the copy application 231. In addition, the copy application 231 will be applied to other output functions such as fax, email, and file upload through the network.

The middleware layer 240 is implemented as firmware to control the image processing apparatus 100. Each module of middleware layer 240 executes various interrupt controls, and provides common functions for each application 231-234 of the application layer 230.

For example, the middleware layer 240 includes a system control service (SCS)/a system resource manager (SRM) 241, an image memory handler (IMH) 242, an engine control service (ECS) 243, a machine information report service (MIRS) 244, a net file application (NFA) 245, and a memory control service (MCS) 246.

The SCS/SRM 241 manager controls the system and the hardware resources. The IMH 242 allocates memory to the process of the invention, and manages the memory allocated to the process. In addition, in this embodiment, the IMH 242 manages an image revision/an image destruction process (for example, color conversion process, or over paint process) of the document image during the unjust copying process. The ECS 243 enables the engine controller 112 to control the scanner engine 211 and the printer engine 212 according to the instructions of a read job and a print job received from each of the applications.

The MIRS 244 includes an E-mailer. The MIRS 244 notifies the observation manager of unjust copying by E-mail when the unjust copy prevention unit 106 judges the document to be copy prohibited.

The unjust copying E-mail notification data includes, for example, apparatus information, a job log, and/or the document image data, and sends the E-mail to a registered e-mail address registered, for example, to the observation manager or the management server 121.

The NFA 245 controls the transmission of the read document image to the management server 121 with protocols such as FTP, HTTP, FTPS, or HTTPS.

The MCS 246 maintains information of the prohibited copied image. The MCS 246 manages preservation of the job log in the memory device 120. The job log may include information regarding the document image and the unjust copying.

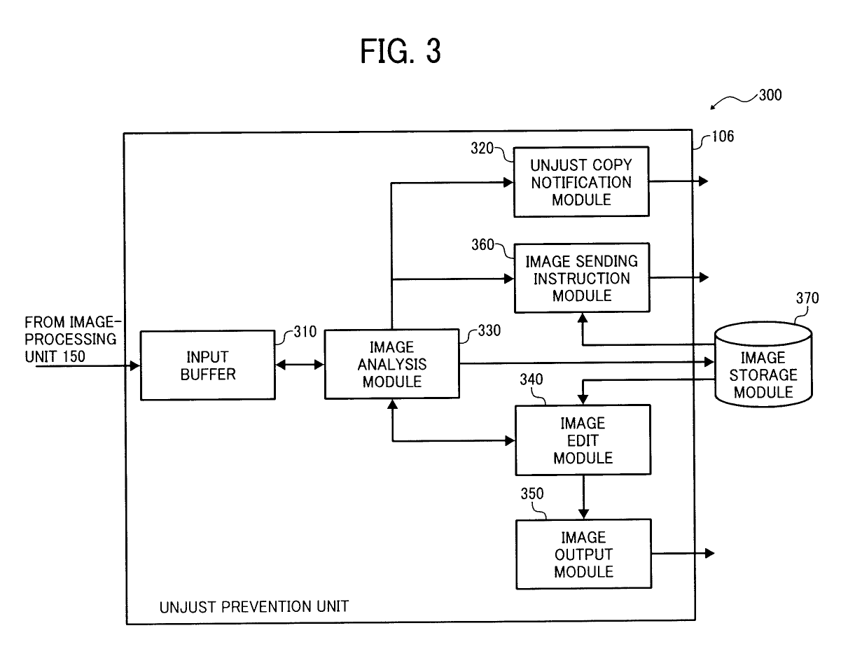

Referring to FIG. 3, the handling result of the unjust copy prevention unit 106 is used for each process such as generating an unjust copy notification, transmitting a document image, and processing a document image using the middleware module group 111.

The unjust prevention unit 106 includes an input buffer 310, an image analysis module 330, an image edit module 340, and an image output module 350. 10036] The input buffer 310 functions as temporary memory of the document image, receives the document image from the image-processing unit 105, and transfers the document image to the image analysis module 330. The image analysis module 330 analyzes the document image received from the input buffer 310, and judges whether the document image includes the copy control information indicating that copying is prohibited. The copy control information can be character strings or a particular image. The character strings can be, for example, “secret”, “confidential” meaning prohibited, or “name”, “phone” meaning private. The particular image can be, for example, a mark indicating that copying is prohibited, a special background watermark, a part of a special image, or a bar code.

The image analysis module 330 stores the document image in the image storage module 360 (for example, a HDD, or silicon memory) according to the result of the image analysis, and in case the document image is prohibited from being copied, notifies the image edit module 340 of the prohibited copying. The image edit module 340 edits the document image.

When notified of a “copy prohibition” from the image analysis module 330, the image edit module 340 destroys the document image, for example, by color editing from full color to mono gray color, or adding a masking pattern to the document image. The image edit module 340 transfers an edited document image to the image output module 350.

In addition, the image edit module 340 may delete the stored document image in the image storage module 360 after transferring the edited document image to the image output module 350 for additional precautions to prevent the document image from being leaked.

On the other hand, when notified of “not copy prohibited” from the image analysis module 330, the document image is passed through the image edit module 340 without editing to the image output module 350.

The image output module 350 transfers the received (edited or non edited) document image to each forwarding address selected by the user, for example, the print engine 212, the FAX unit 115, or E-mailer 244 (MIRS).

Further, the unjust prevention unit 106 includes an image sending instruction module 360, and an unjust copy notification module 320. The image analysis module 330 notifies the image sending instruction module 360 and the unjust copy notification module 320 when it is judged that the document image is copy prohibited.

The unjust copy notification module 320, in response to the notice, instructs the E-mailer to generate a notice of unjust copying and to send the notice. The E-mailer generates the notice of unjust copying including a predetermined notice of unjust copying and the job log. The job log may include a time stamp, apparatus identification information, job identification information, and/or the document image. Then, the E-mailer sends the E-mail to the predetermined address.

The image sending instruction module 360, in response to the notice reads out the document image from the image storage module 360, and sends the document image to the management server 121 through the NIC 111a.

To improve security, the image storage module 360 may refuse access from other applications during the above sequence using a programming technique, for example, “Mutex”, “Semaphore”, “Synchronization Class”, or “Synchronization Method”.

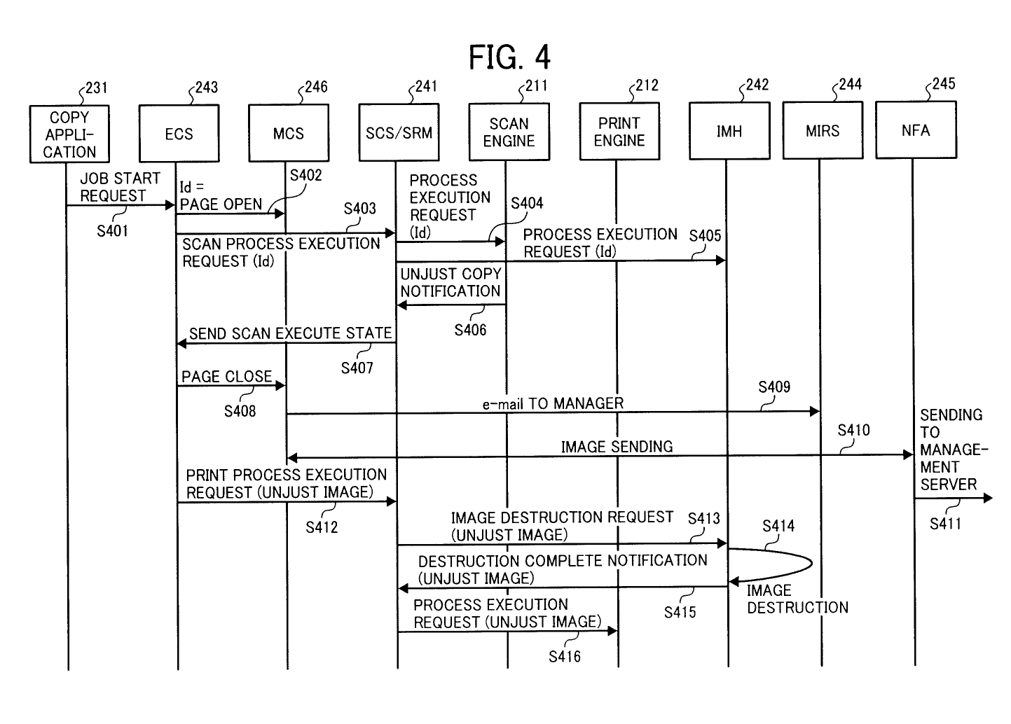

Referring to FIG. 4, the copy application 231 sends a job start request to the ECS 243 (S401). The ECS 243 sends a command “Id=page open” to the MCS 246 (S402), wherein the page open command starts the MCS 246 document registration, and sends a scan process execution request with the Id to the SCS/SRM 241(S403). The SCS/SRM 241 sends the process execution request with the Id to the scan engine 211 (S404), and to the IMH 242 (S405). Then, the scanner engine 211 starts scanning the document. The scan engine 211 acquires the document image from the document. The unjust copy prevention unit 106 judges the document image as shown in FIG. 3. In case the document is prohibited from being copied, the SCS/SRM 241 is provided an unjust copy notification (S406). The SCS/SRM 241 sends a scan execute state to ECS (S407).

The ECS 243 sends a page close command to the MCS 244 to register the image data as the copy prohibition document (S408).

The MCS 244 sends an instruction to the MIRS 244 to send an E-mail to the manager (S409), and sends an instruction to the NFA 245 to send the image data to the management server 121 (S410), (S411). The sequence chart from S412 to S416 is a process implemented by the image edit module 340.

The ECS 243 sends a print process execution request regarding the image data prohibited from copying to the SCS/SRM 241 (S412). The SCS/SRM 241 sends an image destruction request to the IHM 242 (S413). The IHM 242 destroys the image by editing the image data (S414), and sends a destruction complete notification to the SCS/SRM 241 (S415). The SCS/SRM 241 sends a process execution request to the print engine 212 (S416).

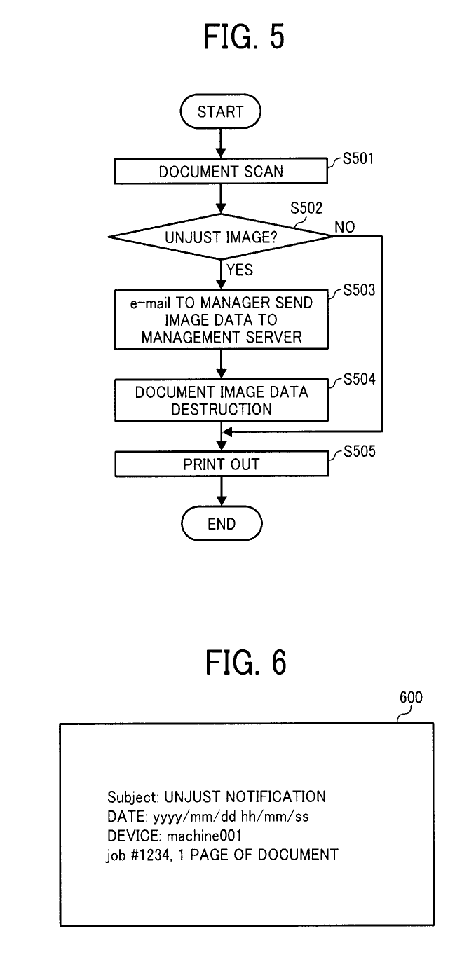

FIG. 5 is a flow chart showing an exemplary method of managing prohibited copy according to an embodiment of the present invention. The entire process is explained as shown in FIG. 4.

FIG. 6 is a diagram showing an exemplary e-mail sent to an observation manager when prohibited copying occurs.

Referring to FIG. 6, the E-mail includes Subject, date, device identification, and a job log.

Furthermore, in the embodiments of the invention, the image processing apparatus 100 may include a peripheral device, for example, a scan unit, or a print unit inside of the image processing apparatus.

1. An image processing apparatus, comprising:
an image input module configured to input a document image;
a detect module configured to detect whether copy control information is provided with document image data of the document image;
a transfer module configured to transfer the document image data through a network in case the detect module detects the copy control information;
an edit module configured to edit the document image data, and create an edited image according to the copy control information; and
an image output module configured to output the edited image.

2. The image processing apparatus as claimed in claim 1, wherein:
the transfer module is configured to send an E-mail to a predetermined address in case the detect module detects the copy control information.

3. The image processing apparatus as claimed in claim 1, wherein:
the edited image is a destroyed version of the document image.

4. An image processing method for processing a document image data, comprising:
inputting a document image;
detecting whether copy control information is provided with document image data;
transferring the document image data through a network in case the copy control information is detected;
editing the document image data to create an edited image according to the copy control information; and
outputting the edited image.

5. The image processing method as claimed in claim 4, further comprising:
transferring an E-mail to a predetermined address in case the copy control information is detected.

6. The image processing method as claimed in claim 4, wherein the editing step comprises:
destroying the document image data.

7. A computer readable storage medium having embodied therein program code for causing a computer to execute an image processing method as claimed in claim 4.

8. An image processing apparatus, comprising:
means for inputting a document image;
means for detecting whether copy control information is provided with document image data of the document image;
means for transferring the document image data through a network in case the means for detecting detects the copy control information;
means for editing the document image data, and for creating an edited image according to the copy control information; and
means for outputting the edited image.

9. The image processing apparatus as claimed in claim 1, wherein:
the means for transferring sends an E-mail to a predetermined address in case the means for detecting detects the copy control information.

10. The image processing apparatus as claimed in claim 1, wherein:
the edited image is a destroyed version of the document image.
